(19) United States
(12) Patent Application Publication
(10) Pub. No.: US 2013/0008066 A1
(43) Pub. Date: Jan. 10, 2013

(54) MODULAR LOCKING TIRE MERCHANDISING DISPLAY RACKING SYSTEM

(76) Inventor: Charles de Martigny, Clearwater Beach, FL (US)

(21) Appl. No.: 13/542,384

(22) Filed: Jul. 5, 2012

Related U.S. Application Data
(60) Provisional application No. 61/504,589, filed on Jul. 5, 2011.

(51) Int. Cl. A47F 7/04; A47F 5/00; G09F 7/18

(52) U.S. Cl. 40/606.03; 211/24; 211/4

(57) ABSTRACT

A modular tire rack which engages tires from the open interior of each tire. The rack may be formed in modular sections which can be assembled in vertically or horizontally adjustable numbers. The rack may incorporate a lock to prevent casual removal of tires. Tires are supported with their full faces available for inspection by potential buyers. Tires are engaged by structure which after assembly occupies the open interior of each tire. The rack may include a floor base accommodating either permanent bolting to a floor or the like or alternatively, attachment of caster wheels. Supports for holding signage may be provided.

### CROSS REFERENCE TO RELATED APPLICATION

This application claims the benefit of the filing date under 35 USC 119(e) of the filing date of U.S. Provisional Application Ser. No. 61/504,589, filed Jul. 5, 2011, the contents of which are incorporated herein.

### FIELD OF THE INVENTION

The present invention relates to racks and more particularly to a modular rack for storing and displaying pneumatic tires.

### BACKGROUND OF THE INVENTION

Automotive facilities selling tires typically use racks to store tires. If security against theft is desired, tires are enclosed within cage type racks. Alternatively, some racks may not enclose tires being stored thereon. In the latter case, it is conventional to pass a chain through the openings of the tires and secure the chain with a padlock. Neither of these types of tire racks is esthetically pleasing. Moreover, conventional racks are not conducive to displaying tires in a manner that will elicit interest by potential buyers. That is, tires are not held apart from one another and presented so as to enable inspection of the entire face of a tire by a potential buyer. Also, storage racks are not adapted to present signage which may promote tire sales.

### SUMMARY OF THE INVENTION

The present invention addresses the above deficiencies in several ways. In one way, tires are held in an attitude enabling passers by to view the full face of each tire. In another way, some of the tire engaging structure occupies the open interior of the tire, thereby being concealed from view. Further, the novel modular rack accommodates signage which may present information of interest to potential buyers, such as what type of vehicle may utilize the displayed tire, characteristics of the tire, and price.

To these ends, the novel rack comprises a floor plate, a vertical mast, and a tire engaging element which may project horizontally from the vertical mast. The vertical mast is arranged to telescopically engage other vertical masts, so that the total number of tire holding units is at the discretion of the user.

The tire engaging element may be formed in two sections which are assembled once inside the opening of the tire. The tire engaging element may incorporate a lock which prevents casual removal of a tire from the novel rack.

Plates, clips, or other structure may be formed integrally with the rack to accommodate signage.

In its simplest form, the novel rack may comprise only one tire engaging element, and may support and display only one tire. Alternatively, tire engaging modules may be vertically stacked to support and display plural tires. In addition to being vertically arrayed, novel racks may be arrayed abreast of one another so as to define a two dimensional display array. If desired, the racks may be extended to form a three dimensional storage and display array.

An object of the invention is to provide a versatile, convenient tire storage and display racking system which presents the full face of a tire for display, which holds the tire securely and deters casual removal, which accommodates signage, and which conceals a substantial amount of utilitarian structure of the rack.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental front perspective view of a modular rack adapted to store and display two tires, according to at least one aspect of the invention.

FIG. 2 is an exploded perspective view of a modular rack according to at least one aspect of the invention.

FIG. 3 is a side detail view of a tire mounted and secured to a modular rack according to at least one aspect of the invention, is shown partially in cross section, and is a view taken from the direction of the arrow 3-3 shown in FIG. 2.

FIG. 4 is an exploded perspective detail view of optional components of a modular rack, according to further aspects of the invention.

FIG. 5 is a perspective view of some components of a modular rack according to at least one aspect of the invention, shown assembled in a vertically arrayed modular stack.

FIG. 6 is front view of a modular rack according to still a further aspect of the invention.

### DETAILED DESCRIPTION

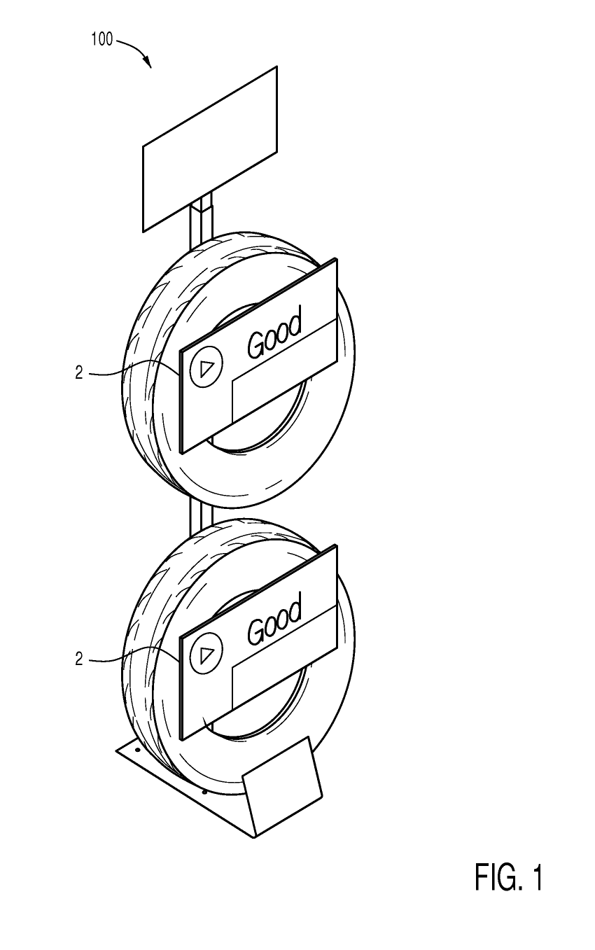

Referring first to FIG. 1, according to at least one aspect of the invention, there is depicted a modular rack 100 for storing and displaying two tires 2. The modular rack 100 holds the tires 2 in an upright orientation with the sidewall 4 of each tire 2 facing an observer (not shown) when the observer is squarely in front of the modular rack 100. This is an advantageous orientation for displaying tires 2 because as much of each tire 2 is exposed to view as is possible. Also, tires such as the tires 2 conventionally bear indicia (not visible in FIG. 1) molded into their sidewalls on the exterior surface, for conveying information about the tire, such as load capacity, nominal tire size, inflation specifications, model and manufacturer, and the like. Signage 4 is also seen to be supported by the modular rack 100. An upper signage support (without a sign supported thereby) and a floor base for the modular rack 100 are also seen.

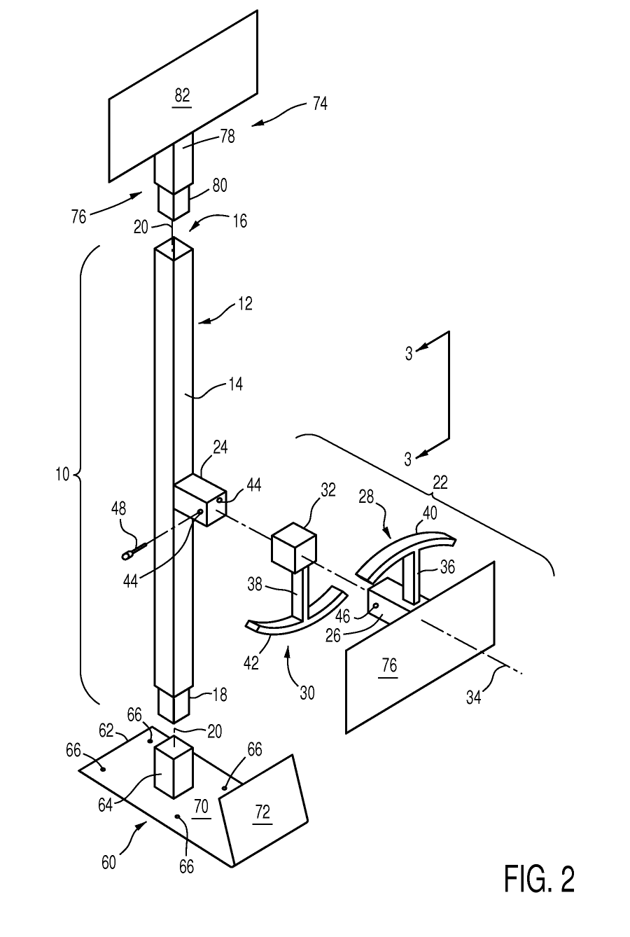

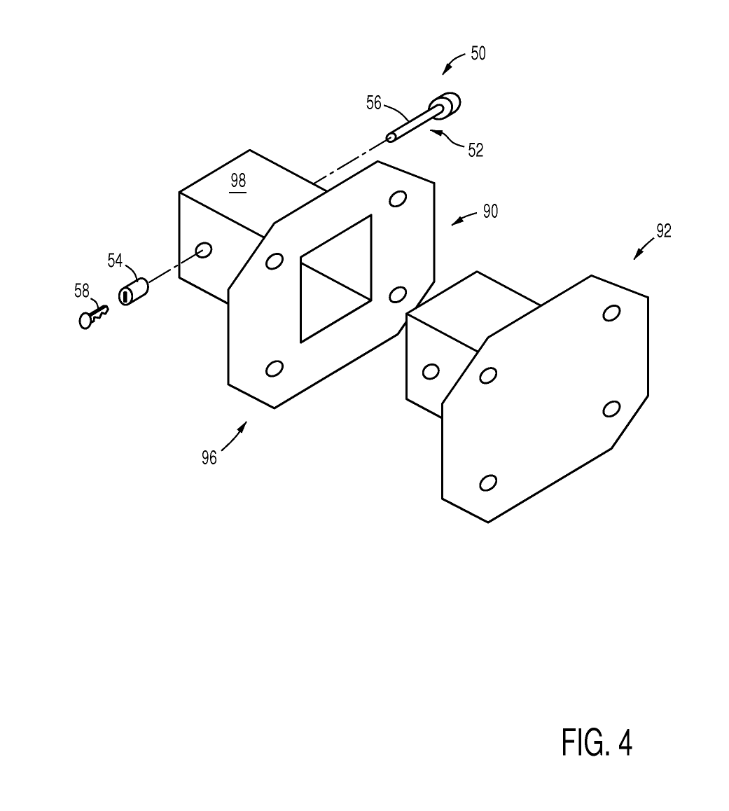

Construction of the modular rack 100 may be understood by turning to FIG. 2. Modular racks such as the modular rack 100 may be formed by modularly assembling tire holding units such as a tire holding unit 10. The tire holding unit 10 may include a vertical mast 12 which preferably comprises a serial connection feature enabling series connection to similar additional vertical masts of additional tire holding units. For example, the vertical mast 12, which is in the example of FIG. 1 a square channel, may include a relatively long section 14 having an open end 16 and a relatively short section 18 of reduced dimensions which is fixed to and may form an extension of the relatively long section 14 in the direction of the longitudinal axis 20 of the vertical mast 12. The dimensions and configuration of the relatively short section 18 enable the relatively short section 18 to engage the open end 16 of the relatively long section 14. Of course, because of the modular nature of a modular rack such as the modular rack 100, the relatively short section 18 is intended to engage the relatively long section of another vertical mast (see FIG. 4) to enable serial connection of plural vertical masts such as the vertical mast 12.

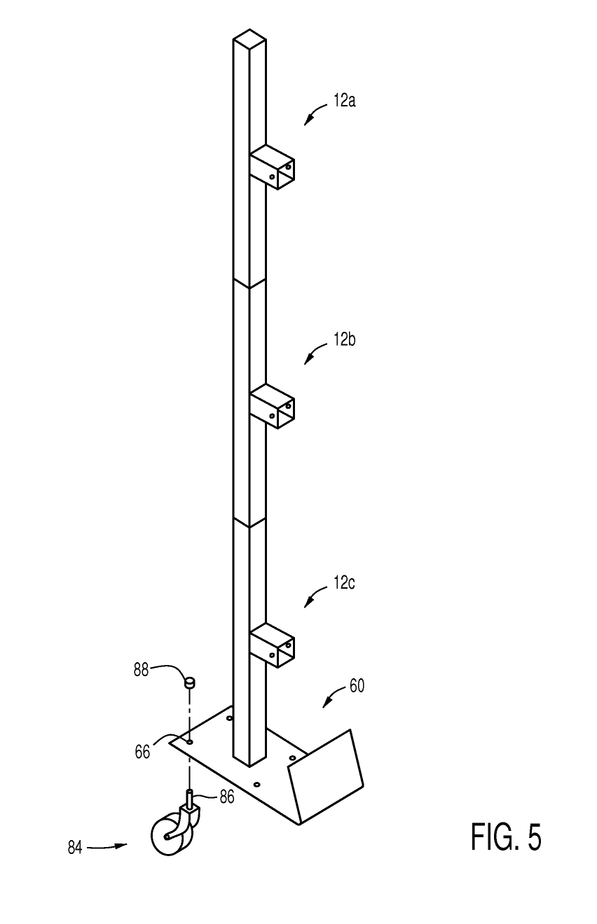

It is preferable but not necessary that the relatively short section 18 be received within the open end of the relatively long section of another vertical mast such as the vertical mast 12. The relatively short section 18 could instead comprise a female socket which receives the relatively long section of another vertical mast (this option is not shown). Still other connection schemes (not shown) could also be employed. It is further preferable although not necessary that the relatively long sections of the vertical masts of modular tire holding units such as the tire holding unit 10 have similar external dimensions and configuration, so that when several modular tire units are serially joined as depicted in FIG. 5, a visual impression of a single vertical mast of constant external dimensions and configuration is achieved.

The tire holding unit 10 may comprise a multipiece tire engaging element 22 which projects horizontally from the vertical mast 12 when the vertical mast 12 is in a vertical orientation as seen in FIG. 2.

It should be noted at this point that orientational terms such as vertical and upright refer to the subject drawing as viewed by an observer. The drawing figures depict their subject matter in orientations of normal use, which could obviously change with changes in orientation and position of the depicted objects. Therefore, orientational terms must be understood to provide semantic basis for purposes of description, and do not limit the invention or its component parts in any particular way.

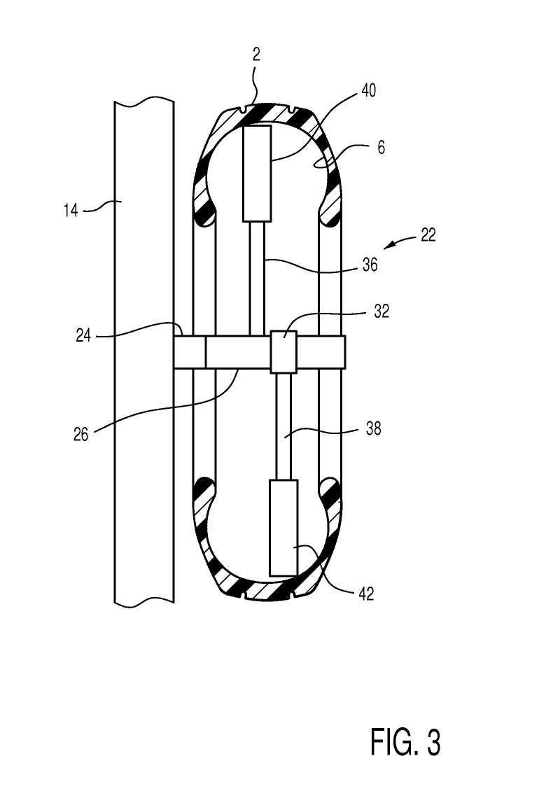

The multipiece tire engaging element 22 may be disposed to be assembled so as to partially occupy the open center of a tire such as the tires 2. More particularly, the multipiece tie engaging element 22 may be disposed to engage the inner surface of the tire 2 at two diametrically opposed points at the inner surface of the tire 2, and to hold the tire 2 from the inside of the tire 2 in an upright orientation as seen in FIG. 1. Engagement of a tire 2 in this manner is shown in FIG. 3, which may be briefly consulted now for better understanding of the invention but which will be described in greater detail hereinafter. The multipiece tire engaging element 22 may comprise a first non-circular stub channel 24 permanently fixed to and projecting laterally from the vertical mast 12, a second and separate non-circular stub channel 26 which is dimensioned and configured to be telescopically received by the first non-circular stub channel 24, a first lateral projection 28 which engages the inner surface of the tire 2 and which is fixed to one of the first non-circular stub channel 24 and the second non-circular stub channel 26, and a second lateral projection 30 which slidably fits to one of the first non-circular stub channel 24 and the second non-circular stub channel 26 and may be slid thereon so as to project in a direction opposite that of the first lateral projection 28. As depicted in FIG. 2, the first lateral projection 28 is fixed to the second non-circular stub channel 26.

The first non-circular stub channel 24 and the second non-circular stub channel 26, both shown as square channel in the example of FIG. 2, need not be square in cross section as depicted. Rather, they merely need be configured to prevent rotation of the socket 32 of the second lateral projection 30 so that the latter will maintain its direction of projection from the axis 34 of the multipiece tire engaging element 22 in the direction opposite that of the first lateral projection 28.

The first lateral projection 28 and the second lateral projection 30 may comprise respective stems 36, 38 and respective wheel contacting portions 40, 42 each of which generally conforms to the curvature of the interior of a tire such as the tires 2. Although depicted as arcuate, the wheel contacting portions 40, 42 need not be literally arcuate or curved, as long as each presents at least one point of contact which would establish interference with the interior surface of the tire 2 so as to prevent casual removal of the tire 2 from the multipiece tire engaging element 22. As employed herein, the phrase “at least one” explicitly contemplates one of the referenced item and also any number greater than one of the referenced item. Furthermore, it is not necessary that both of the wheel contacting portions 40, 42 literally contact the inner surface of the tire 2, as long as interference preventing casual removal is achieved.

As employed herein, casual removal signifies removal by manual manipulation, as might be attempted by a person attempting to remove the tire 2 for example to steal the same.

FIG. 3 shows the multipiece tire engaging element 22 in the asembled condition partially occupying the open center of a tire 2 and achieving interference with casual removal of the tire 2 from the multipiece tire engaging element 22 as discussed above. In FIG. 3, the wheel contacting portion 40 is seen to abut the interior surface 6 of the tire 2. The wheel contacting portion 42 projects sufficiently far into the open center of the tire 2 so as to prevent the tire 2 from being manually maneuvered free of the multipiece tire engaging elmeent 22. Removal of the tire 2 may be accomplished only by disassembling the multipiece tire engaging element 22.

Assembly and disassembly of the multipiece tire engaging element 22 are explained with reference to FIGS. 2 and 4. The first non-circular stub channel 24 and the second non-circular stub channel 26 each have a respective hole 44 or 46 each of which is alignable with a the corresponding hole 46 or 44 formed in the other of the first non-circular stub channel 24 and the second non-circular stub channel 26. As seen in FIG. 2, a pin 48 is dimensioned and configured to pass through the alignable holes 44, 46 in close cooperation therewith. Referring to FIG. 4, the pin 48 may comprise a lock such as a locking pin 50 which may be locked to prevent casual disassembly of the multipiece tire engaging element 22. The pin 50 may comprise a bolt 52 and a removable head 54 which may only be removed from the shaft 56 of the bolt 52 when unlocked for example by a key 58. If desired, other locking arrangements such as padlocks having elongated shackles (not shown) may be provided in place of the pin 48 or the locking pin 50.

Referring again to FIG. 2, a modular rack such as the modular rack 100 may comprise a floor base 60 which may be manually attachable to the vertical mast 12. The floor base 60 may comprise a plate 62 to which may be fixed a mounting stub 64 for telescopically receiving the relatively short section 18 of the vertical mast 12. The plate 62 may comprise mounting holes 66 selectively enabling bolting of the floor base 60 to an environmental surface (not shown) bearing upwardly projecting studs which may be passed through the mounting holes 66, bolting of the floor base 60 to resilient feet (not shown), and bolting of the floor base 60 to wheels such as the caster wheel 68 shown in FIG. 5.

The plate 62 of the floor base 60 may comprise a first panel 70 which is horizontal when the vertical mast 12 is in a vertical orientation as seen in FIG. 2, and a second signage support panel 72 which is arranged at an angle to the first panel 70. The first panel 70 and second panel 72 may be formed by bending the plate 62 for example.

The tire holding unit 10 may comprise a separate and attachable upper signage support 74 which is disposed to hold a sign (not shown) above a tire 2 held by the multipiece tire engaging element 22. The upper signage support 74 may have a stepped stub shaft 76 having a relatively large section 78 and a relatively small section 80 the latter of which may be dimensioned and configured to be telescopically received by the open end 16 of the vertical mast 12 in the same way as other vertical masts are received. When plural tire holding units such as the tire holding unit 10 are joined in vertical series, for example, as seen in FIG. 1, the upper signage support 74 may be connected to the vertical mast 12 of the uppermost tire holding unit 10. The upper signage support may comprise a support plate 82 to which a sign (not shown) may affixed.

The multipiece tire engaging element 22 may comprise a front signage support 76 disposed to hold a sign over the open center of a tire 2 (as seen in FIG. 1 for example), with the tire 2 and the sign occupying parallel planes and the sign being displayed immediately in front of the tire 2.

Referring now to FIG. 5, a modular rack according to the invention may comprise a plurality of tire holding units arrayed as a vertical stack. In FIG. 5, the tire holding units, which may be similar to the tire holding unit 22 shown in FIG. 2 for example, are shown representatively by vertical masts 12a, 12b, and 12c, each of which may be similar to the vertical mast 12 of FIG. 2. The lowermost vertical mast 12c may be connected to a floor base such as the floor base 60. Multipiece tire engaging elements such as the multipiece tire engaging element 22 may be subsequently assembled to the mast assembly comprising the vertical masts 12a, 12b, and 12c. A signage support such as the upper signage support 74 may be installed on the uppermost vertical mast 12a.

FIG. 5 also illustrates mounting of a wheel such as a caster wheel 84 to the floor base 60. The stud 86 of the caster wheel 84 may be passed through a mounting hole 66 and appropriately secured with a fastener asembly 88. The fastener assembly 88 is shown in representative form only, and may include plural components including a nut and a lock washer for example.

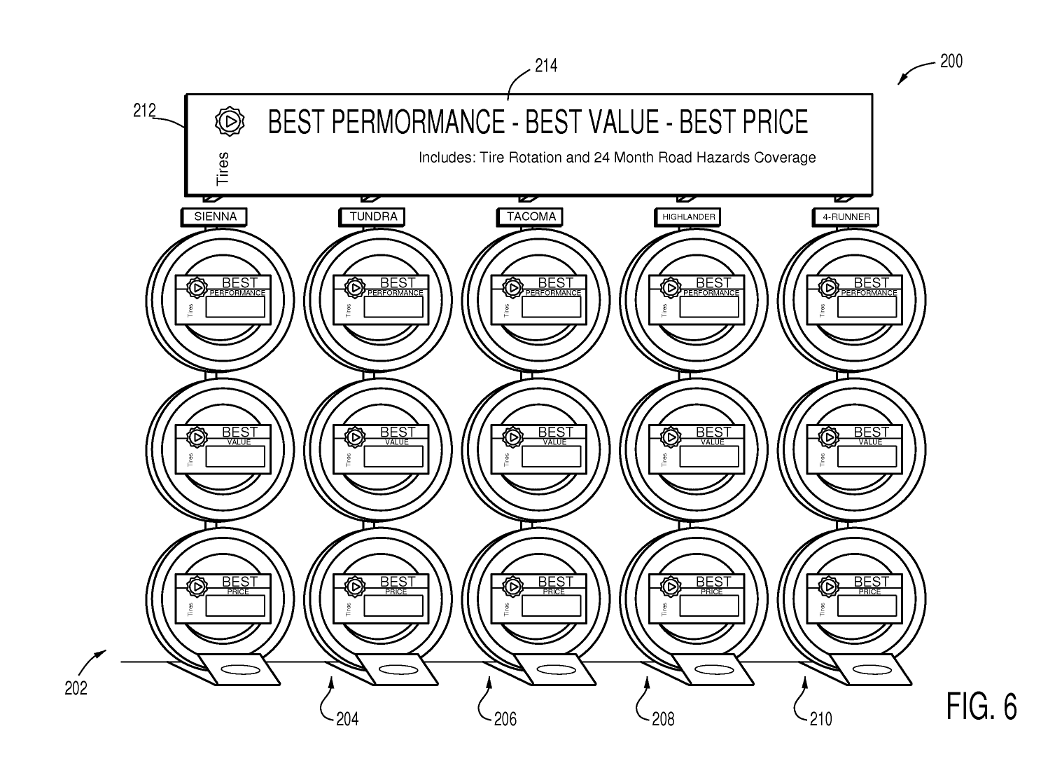

Thus far, illustration of a modular rack such as the modular rack 100 of FIG. 1 has been limited to only one vertical stack of tire holding units such as the tire holding unit 22 of FIG. 2. However, and with reference to FIG. 6, a modular rack 200 may comprise a plurality of vertical stacks 202, 204, 206, 208, 210 of tire holding units such as the tire holding unit 10 of FIG. 2 are arrayed as a two dimensional array wherein individual vertical stacks 202, 204, 206, 208, 210 of tire tire holding units are abreast of one another. A spanning signage support 212 (barely visible behind the sign 214, but which may be similar to the upper signage support 74 of FIG. 2 in its essential functional features may be disposed to span all of the vertical stacks 202, 204, 206, 208, 210.

Referring again to FIG. 4, there is shown an optional wheel bolt lock cover 90 and an optional wheel plate 92 which may be installed to a non-circular stub channel such as the first non-circular stub channel 24 in a telescopic manner utilizing a pin in the same manner as installation of the second non-circular stub channel 26. The wheel bolt lock cover 90 may include a wheel mounting plate 94 bearing a hole pattern 96 disposed to accept fasteners, and a non-circular wheel adapter stub shaft 98 which is fixed to the wheel mounting plate 90 at one end and at an opposed end is dimensioned and configured to be telescopically received by the first non-circular stub channel 24 of the vertical mast 12 (see FIG. 2).

The wheel plate 92 may include a non-circular wheel plate stub shaft 98 which telescopically engages the first non-circular stub channel 24 and the wheel plate stub shaft 98.

Although it is contemplated that because it is desirable that tires be supported within convenient viewing height of potential buyers, the rack assembly will be between one and four units high, it would be possible to stack units in greater numbers if desired.

A tire holding unit such as the tire holding unit 10 may be increased in capacity to hold and display more than one tire if desired.

Connections of modular components of a modular rack according to the present invention may be manual, such as relying upon friction fit or using manually removable fasteners, or alternatively, may be secured by locks, such as that employing the locking pin 50 seen in FIG. 4 for example.

It should be understood that signage supports such as signage support panel 72, upper signage support 74, support plate 82, and spanning signage support 212 are shown in representative capacity only, and may include pockets, clips, and other apparatus (none shown) for engaging, supporting, and holding removable signs.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A modular rack for storing and displaying tires, comprising at least one tire holding unit including a vertical mast comprising a serial connection feature enabling series connection to similar additional vertical masts of additional tire holding units, and a multipiece tire engaging element which projects horizontally from the vertical mast, is disposed to be assembled so as to partially occupy the open center of a tire and to engage the inner surface of the tire at two diametrically opposed points at the inner surface of the tire, and holds the tire from the inside of the tire in an upright orientation.

2. The modular rack of claim 1, wherein the tire holding unit comprises a lock which secures the multipiece tire engaging element in the assembled condition partially occupying the open center of the tire, whereby casual removal of the tire from the modular rack is prevented.

3. The modular rack of claim 1, further comprising a floor base which is manually attachable to the vertical mast.

4. The modular rack of claim 3, wherein the floor base comprises mounting holes selectively enabling bolting of the floor base to an environmental surface, bolting of the floor base to resilient feet, and bolting of the floor base to wheels.

5. The modular rack of claim 1, wherein the tire holding unit comprises an upper signage support disposed to hold a sign above the tire.

6. The modular rack of claim 5, wherein the signage support is dimensioned and configured to be telescopically received within the vertical mast.

7. The modular rack of claim 1, wherein the tire holding unit comprises a front signage support disposed to hold a sign over the open center of the tire, with the tire and the sign occupying parallel planes.

8. The modular rack of claim 1, wherein the multipiece tire engaging element comprises
a first non-circular stub channel permanently fixed to the vertical mast;
a second non-circular stub channel which is dimensioned and configured to be telescopically received by the first non-circular stub channel;
a first lateral projection which engages the inner surface of the tire and which is fixed to one of the first non-circular stub channel and the second non-circular stub channel; and
a second lateral projection which slidably fits to one of the first non-circular stub channel and the second non-circular stub channel and may be slid thereon so as to project in a direction opposite that of the first lateral projection.

9. The modular rack of claim 8, wherein the first lateral projection comprises a wheel contacting portion which generally conforms to the curvature of the interior of a tire.

10. The modular rack of claim 8, wherein the second lateral projection comprises a wheel contacting portion which generally conforms to the curvature of the interior of a tire.

11. The modular rack of claim 3, wherein the floor base comprises a first panel which is horizontal when the vertical mast is in a vertical orientation, and a second signage support panel which is arranged at an angle to the first panel.

12. The modular rack of claim 8 wherein the first non-circular stub channel and the second non-circular stub channel each has at least one hole which is alignable with a corresponding hole formed in the other of the first non-circular stub channel and the second non-circular stub channel, and further comprising a pin which is dimensioned and configured to pass through the alignable holes in close cooperation therewith.

13. The modular rack of claim 12, wherein the pin is a locking pin which may be locked to prevent casual disassembly of the multipiece tire engaging element.

14. The modular rack of claim 1 wherein the vertical mast comprises a relatively long section having an open end and a relatively short section fixed to the relatively long section, and wherein the relatively short section is dimensioned and configured to be received within the open end of the relatively long section, whereby plural similar vertical masts may be joined in series in modular fashion.

15. The modular rack of claim 1, comprising a plurality of tire holding units arrayed as a vertical stack.

16. The modular rack of claim 1, comprising a plurality of vertical stacks of tire holding units arrayed as a two dimensional array wherein individual vertical stacks of tire tire holding units are abreast of one another, and further comprising a spanning signage support disposed to span all of the vertical stacks.

17. The modular rack of claim 1, further comprising a wheel bolt lock cover including a wheel mounting plate bearing a hole pattern disposed to accept fasteners, and a non-circular wheel adapter stub shaft which is fixed to the wheel mounting plate at one end and at an opposed end is dimensioned and configured to be telescopically received by the first non-circular stub channel of the vertical mast.
